(19) United States
(12) Patent Application Publication
(10) Pub. No.: US 2017/0338520 A1
(43) Pub. Date: Nov. 23, 2017

(54) BATTERY DEVICE AND BATTERY CONNECTION MODULE

(71) Applicant: Molex, LLC, Lisle, IL (US)

(72) Inventors: Kian Heng LIM, Singapore (SG); Siow Pheng GOH, Singapore (SG)

(73) Assignee: Molex, LLC, Lisle, IL (US)

(21) Appl. No.: 15/486,471

(22) Filed: Apr. 13, 2017

(30) Foreign Application Priority Data
May 20, 2016 (CN) 201610341706.3

(51) Int. Cl. H01M 10/42; H01M 2/20; H01M 2/10; H01R 25/16; H01R 12/71

(52) U.S. Cl. CPC H01M 10/425; H01R 25/165; H01R 12/716; H01M 2/1077; H01M 2/206; H01M 2010/4271

(57) ABSTRACT

A battery device and a battery connection module are provided. The battery device includes a pack, a connection module, a management circuit board and an electrical connecting unit. The connection module includes an insulating frame having an assembling side, electrode connecting members, extension terminals and an adapter circuit board. The connecting members are provided to the frame and connect the electrode of the pack. The terminals are provided to the frame and respectively correspond to the connecting members. Each terminal has a fixed segment embedded to the frame, an internal connection segment exposed to the frame and connected with the corresponding connecting member and an external connecting segment extending out of the side of the frame. The adapter circuit board is fixed to the side of the frame and connects with the external connecting segments of the terminals. The connecting unit connects the management and adapter circuit boards.

### RELATED APPLICATIONS

This application claims priority to Chinese Application No. 201610341706.3, filed May 20, 2016, which is incorporated herein by reference in its entirety.

### TECHNICAL FIELD

The present disclosure relates to a battery device, particularly relates to a rechargeable battery device and a battery connection module.

### BACKGROUND ART

Generally, a rechargeable battery pack comprises a plurality of batteries, in order to monitor an operative state of each battery and make the battery pack have the best performance, it is common to connect a battery pack to a battery management system (BMS). The function of the existing battery management system includes battery parameter detection, battery state estimation, online fault diagnosis, battery safety control and alarm, charge control, battery balancing, thermal management, networking, information storage, electromagnetic compatibility, etc.

Usually a circuit board provided with a battery management system is directly welded with the battery pack. For example, a secondary battery pack is disclosed in United States patent application publication No. 2010/0124693A1, in which a plurality of bus-bars are welded with battery electrodes and are welded with a battery management circuit board. Because the bus bar needs to be welded with the battery electrodes first and then be welded with the battery management circuit board, the procedure has more processes and is complicated, and if the operation of the welding is careless, it will damage electronic component(s) on the battery management circuit board, thereby resulting in the entire battery pack to be scrapped. Moreover, for example, Chinese patent application No. 03106846.4 (corresponding to U.S. Pat. No. 7,141,330) discloses a battery accommodation case and discloses an embodiment in which batteries are accommodated, in the embodiment, electrodes of batteries are connected by a plurality of tabs and the tabs are connected to a control circuit via a plurality of lead wires. The control circuit includes a battery side board provided at a battery side, a connector side board spaced apart from the battery side board, and a plurality of pin headers for interconnecting the two boards. Because these lead wires need to be individually welded with the tabs and the battery side board, the wiring and welding operation are complicated. In addition, the battery side board and the connector side board are welded with each other via the pin headers, which may not be problematic for a small battery pack, but for a larger battery pack (e.g. a vehicle battery pack), the control system and the battery pack are expensive, when the battery perishes or is damaged, it is necessary to replace the entire battery pack, thereby resulting in high maintenance cost.

### SUMMARY

Therefore, one object of the present disclosure is to provide a battery device, which may resolve the above problems.

Therefore, another object of the present disclosure is to provide a battery connection module, which can be conveniently mounted to a battery pack.

Thus, in some embodiments of the present disclosure, a battery device comprises a battery pack, a battery connection module, a battery management circuit board and an electrical connecting unit. The battery pack comprises a plurality of batteries, each battery has two electrodes. The battery connection module comprises an insulating frame having an assembling side, a plurality of electrode connecting members, a plurality of extension terminals and an adapter circuit board. The plurality of electrode connecting members are provided to the insulating frame and connect the electrodes of the battery pack. The plurality of extension terminals are provided to the insulating frame and respectively correspond to the plurality of electrode connecting members, each extension terminal has a fixed segment embedded to the insulating frame, an internal connecting segment exposed to the insulating frame and connected with the corresponding electrode connecting member and an external connecting segment extending out of the assembling side of the insulating frame. The adapter circuit board is fixed to the assembling side of the insulating frame and connects with the external connecting segments of the plurality of extension terminals. The electrical connecting unit connects the battery management circuit board and the adapter circuit board to make the battery management circuit board detachably connected with the adapter circuit board.

In some embodiments, in the plurality of electrode connecting members, multiple electrode connecting members are bus-bars, each bus-bar has at least two electrode connecting portions to respectively connect the electrodes of adjacent batteries and at least one arched buffer segment to connect adjacent electrode connecting portions.

In some embodiments, in the plurality of electrode connecting members, two electrode connecting members are output electrode members and the other electrode connecting members are the bus-bars, the battery connection module further comprises two extending tabs connecting the two output electrode members respectively and extending out of the assembling side.

In some embodiments, the battery connection module further comprises at least one sensing unit which is provided to the insulating frame, each sensing unit comprises a sensor attached to one of the bus-bars and two wires to connect each sensor and the adapter circuit board.

In some embodiments, the sensing unit further comprises two wire clamping terminals which each are connected to a distal end of one of the two wires and are welded to the adapter circuit board.

In some embodiments, the insulating frame has at least one wire accommodating groove, each wire accommodating groove accommodates the two wires of each sensing unit.

In some embodiments, the insulating frame further has a bottom side connecting the battery pack, a top side opposite to the bottom side and a plurality of accommodating grooves respectively accommodating the plurality of electrode connecting members, and the assembling side is a side of an outer periphery of the insulating frame, each accommodating groove communicates the bottom side and the top side.

In some embodiments, the internal connecting segment of each extension terminal extends into the corresponding accommodating groove and is welded to the corresponding electrode connecting member.

In some embodiments, two walls defining each accommodating groove and opposite to each other each are formed with a first stopping block close to the bottom side and a second stopping block close to the top side, a distance between the first stopping block and the second stopping block is greater than a thickness of the electrode connecting member so as to allow the electrode connecting member to move in a limited range in a vertical direction which vertically passes through the bottom side and the top side before the electrode connecting member is connected and fixed with the corresponding electrode.

In some embodiments, the plurality of electrode connecting members each are made of aluminum-based metal material, the plurality of extension terminals each are made of copper-based metal material.

In some embodiments, the electrical connecting unit comprises a first connector provided to the adapter circuit board, a second connector provided to the battery management circuit board and a cable pluggably connected with the first connector and the second connector.

In some embodiments, the electrical connecting unit comprises an insulating body and a plurality of conductive terminals fixed to the insulating body, each conductive terminal has two compliance portions respectively at opposite ends, in which one compliance portion passes through a corresponding via of the adapter circuit board, and the other compliance portion passes through a corresponding via of the battery management circuit board.

In some embodiments, the electrical connecting unit comprises an insulating body and a plurality of conductive terminal fixed to the insulating body, each conductive terminal has a compliance portion and a welding portion respectively at opposite ends, the compliance portion passes through a corresponding via of one of the adapter circuit board and the battery management circuit board, and the welding portion is welded to the other of the adapter circuit board and the battery management circuit board.

In some embodiments, the electrical connecting unit comprises an insulating body and a plurality of conductive terminals fixed to the insulating body, each conductive terminal has a welding portion and an elastic contacting portion, the welding portion is welded to one of the adapter circuit board and the battery management circuit board, and the elastic contacting portion contacts a corresponding connection pad provided to the other of the adapter circuit board and the battery management circuit board.

In some embodiments of the present disclosure, a battery connection module comprises an insulating frame, a plurality of electrode connecting members, a plurality of extension terminals and an adapter circuit board. The insulating frame has an assembling side; the plurality of electrode connecting members are provided to the insulating frame; the plurality of extension terminals are provided to the insulating frame and respectively correspond to the electrode connecting members, each extension terminal is partially embedded to the insulating frame and has an internal connecting segment exposed to the insulating frame and connected with the corresponding electrode connecting member and an external connecting segment extending out of the assembling side of the insulating frame; the adapter circuit board is fixed to the assembling side of the insulating frame and connected with the external connecting segments of the plurality of extension terminals.

The present disclosure at least has following effects: the insulating frame, the plurality of electrode connecting members, the plurality of extension terminals and the adapter circuit board together form the battery connection module, an assembling process of assembling them with the battery pack can be simplified. And, the battery management circuit board can be detachably connected with the adapter circuit board, which not only can avoid damage to the battery management circuit board during the welding process of the plurality of electrode connecting members and the electrodes of the battery pack, but also when one of the battery pack and the battery management circuit board fails, it only needs to replace the failed one, the whole battery device will not be scrapped, so that the maintenance cost can also be saved.

### BRIEF DESCRIPTION OF THE DRAWINGS

Other features and effects of the present disclosure will be apparent from the embodiments with reference to figures, in which:

FIG. 1 is a perspective view of a first embodiment of a battery device of the present disclosure;

FIG. 2 is an exploded perspective view of the first embodiment;

FIG. 3 is a top view of the first embodiment;

FIG. 4 is an exploded perspective view of a battery connection module of the first embodiment;

FIG. 5 is a perspective view of a plurality of electrode connecting members, a plurality of extension terminals and two extending tabs of the first embodiment;

FIG. 6 is an exploded perspective view of an insulating frame and the plurality of extension terminals of the first embodiment;

FIG. 7 is an exploded perspective view of the first embodiment with only a part of the first embodiment illustrated;

FIG. 8 is a perspective view of a second embodiment of the battery device of the present disclosure;

FIG. 9 is a side view of the second embodiment;

FIG. 10 is an exploded perspective view of the second embodiment;

FIG. 11 is an exploded perspective view of an electrical connecting unit of the second embodiment;

FIG. 12 is an exploded perspective view of a third embodiment of the battery device of the present disclosure;

FIG. 13 is the a perspective view of an electrical connecting unit of the third embodiment;

FIG. 14 is a perspective view of a fourth embodiment of the battery device of the present disclosure;

FIG. 15 is a side view of the fourth embodiment;

FIG. 16 is an exploded perspective view of the fourth embodiment; and

FIG. 17 is an exploded perspective view of an electrical connecting unit of the fourth embodiment.

### DETAILED DESCRIPTION OF THE PREFERRED EMBODIMENTS

Before the present disclosure is described in detail, it should be noted that like elements are indicated by the same reference numerals in the following description.

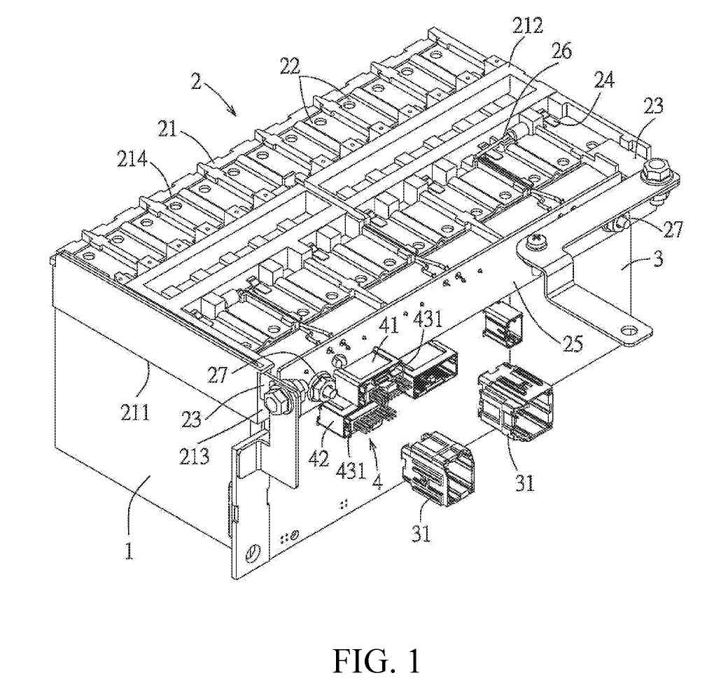

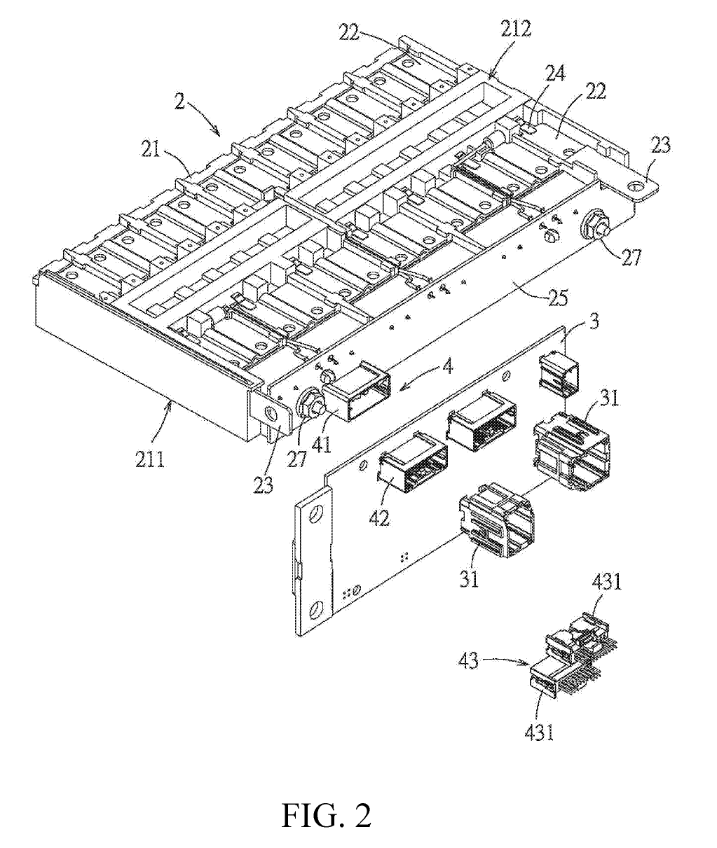

Referring to FIGS. 1 and 2, a first embodiment of a battery device of the present disclosure comprises a battery pack 1, a battery connection module 2, a battery management circuit board 3 and an electrical connecting unit 4. The battery pack 1 comprises a plurality of batteries (not shown), each battery has two electrodes (not shown).

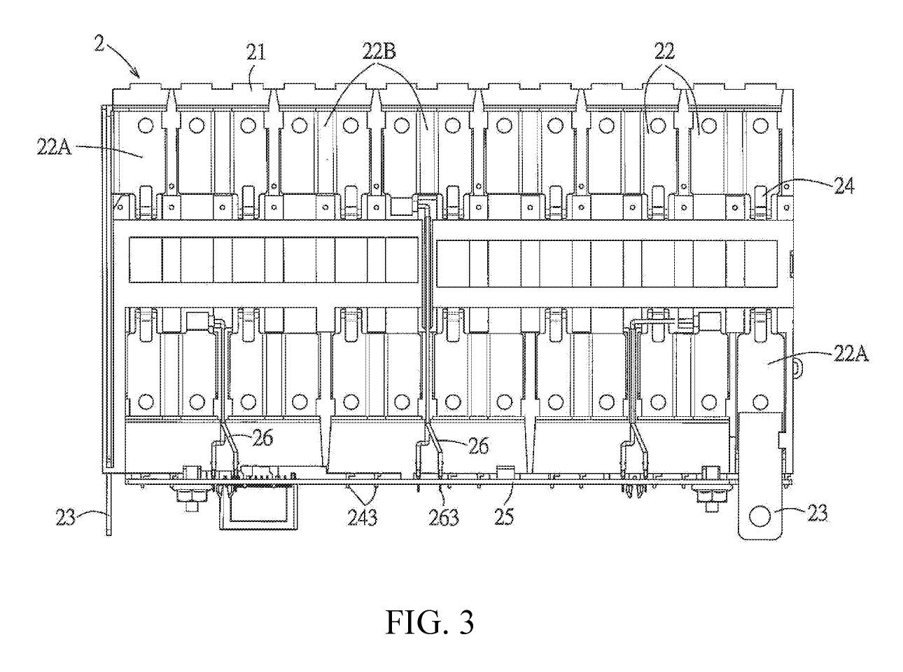

Referring to FIG. 3 through FIG. 5, the battery connection module 2 comprises an insulating frame 21, a plurality of electrode connecting members 22, a plurality of extension terminals 24 and an adapter circuit board 25. The insulating frame 21 has a bottom side 211 which connects the battery pack 1 (see FIG. 1), a top side 212 which is opposite to the bottom side 211 and an assembling side 213. In an embodiment, the assembling side 213 is a long side of an outer periphery of the insulating frame 21.

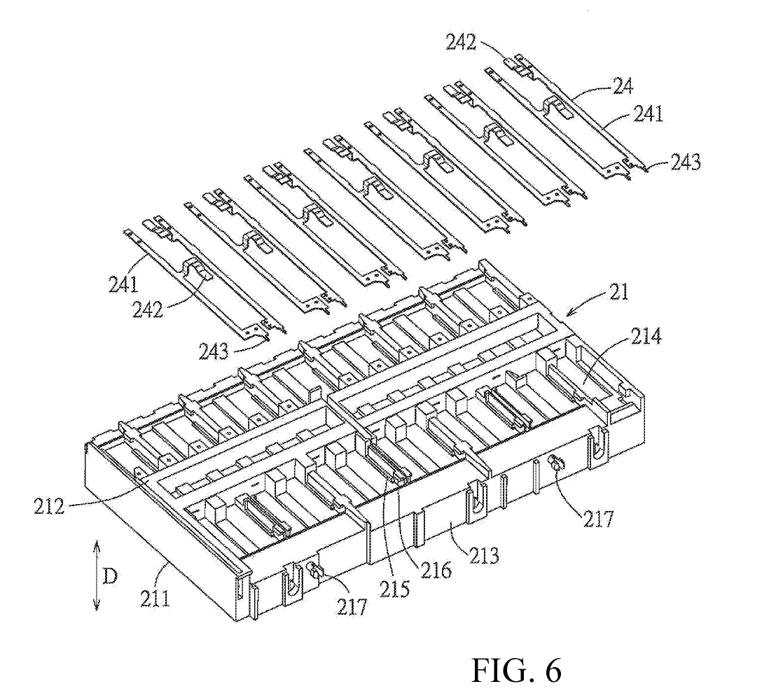

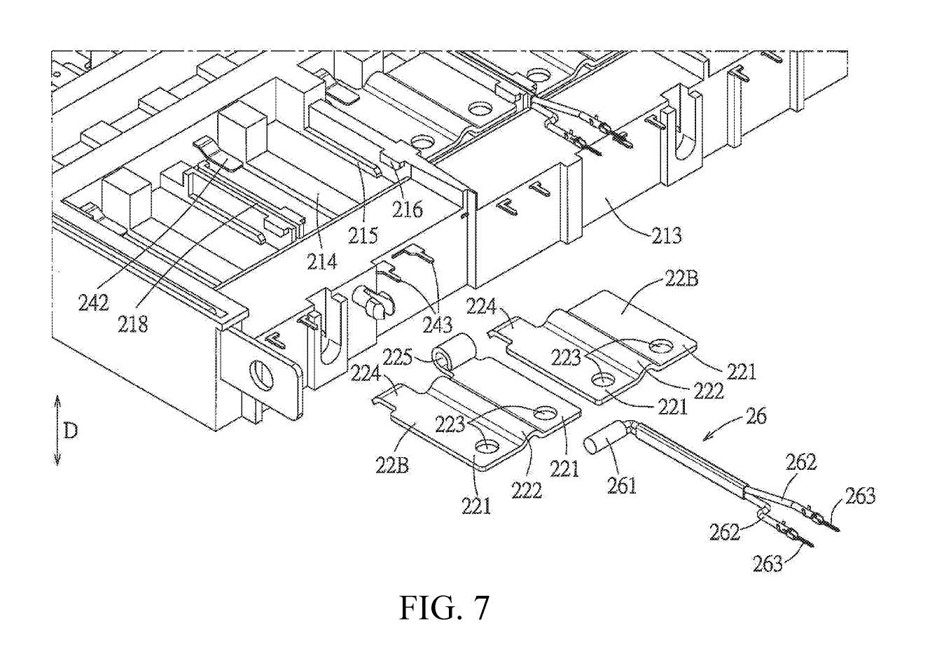

The plurality of electrode connecting members 22 are provided to the insulating frame 21 and connect the electrodes of the battery pack 1. Also referring to FIG. 6 and FIG. 7, the insulating frame 21 further has a plurality of accommodating grooves 214 which accommodate the plurality of electrode connecting members 22 respectively, each accommodating groove 214 communicates the bottom side 211 and the top side 212, and two walls defining each accommodating groove 214 and opposite to each other each are formed with a first stopping block 215 close to the bottom side 211 and a second stopping block 216 close to the top side 212. A distance between the first stopping block 215 and the second stopping block 216 is greater than a thickness of the electrode connecting member 22, so as to allow the electrode connecting member 22 to move in a limited range in a vertical direction D which vertically passes through the bottom side 211 and the top side 212 before the electrode connecting member 22 is connected and fixed with the corresponding electrode. In the embodiment, in the plurality of electrode connecting members 22, two electrode connecting members 22 are output electrode members 22A and the other the electrode connecting members 22 are bus-bars 22B, each bus-bar 22B has at least two electrode connecting portions 221 to connect the electrodes of adjacent batteries respectively and at least one arched buffer segment 222 to connect adjacent electrode connecting portions 221. Each output electrode member 22A and each electrode connecting portion 221 of each bus-bar 22B each are provided with a through hole 223 so as to allow one corresponding electrode to pass through. The battery connection module 2 further comprises two extending tabs 23 connecting the two output electrode members 22A respectively and extending out of the assembling side 213.

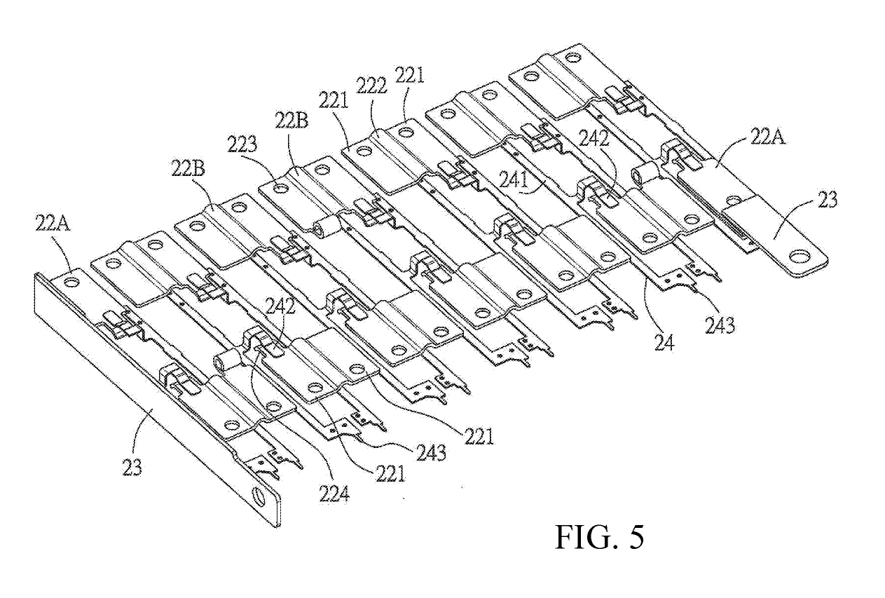

Referring to FIG. 5 through FIG. 7, the plurality of extension terminals 24 are provided to the insulating frame 21 and respectively correspond to the plurality of the electrode connecting members 22, each extension terminal 24 has a fixed segment 241 embedded to the insulating frame 21, an internal connecting segment 242 exposed to the insulating frame 21 and connected with the corresponding electrode connecting member 22 and an external connecting segment 243 extending out of the assembling side 213 of the insulating frame 21. In the embodiment, the insulating frame 21 is formed by insert molding, so as to embed and fix the fixed segment 241 of each extension terminal 24. Moreover, in the embodiment, the internal connecting segment 242 of each extension terminal 24 extends into the corresponding accommodating groove 214, each electrode connecting member 22 has a lapped portion 224, the lapped portion 224 corresponds to the internal connecting segment 242 of the corresponding extension terminal 24 in position. When the plurality of electrode connecting members 22 are mounted to the insulating frame 21, the plurality of electrode connecting members 22 are placed into the plurality of accommodating grooves 214 respectively from two sides of a length direction of the insulating frame 21, and then the internal connecting segment 242 of each extension terminal 24 is welded to the lapped portion 224 of the corresponding electrode connecting member 22. When the plurality of electrode connecting members 22 are correspondingly welded with the electrodes of the battery pack 1, by that each electrode connecting member 22 can move between the first stopping block 215 and the second stopping block 216 in the limited range in the vertical direction D, each electrode connecting member 22 can be adjusted in position to match with the corresponding electrodes, so as to ensure that the electrode connecting member 22 can be welded with the corresponding electrodes together. In an embodiment, the bus-bars 22B each can be made of aluminum-based metal material, so as to conveniently be welded with the electrodes, which each are made of aluminum-based metal, of the battery pack 1 in the same material, such as by laser welding or ultrasonic welding. In an embodiment, the two output electrode members 22A each can be made of copper-based metal material and an aluminum-based metal gasket is provided to a bottom of each output electrode member 22A and is welded with the corresponding aluminum-based metal electrode of the battery pack 1. In an embodiment, the extension terminals 24 each are made of copper-based metal material so as to have better electrical conductivity.

Further referring to FIG. 2 through FIG. 4, the adapter circuit board 25 is fixed on the assembling side 213 of the insulating frame 21 and is connected with the external connecting segments 243 of the plurality of extension terminals 24. In the embodiment, the insulating frame 21 has two latching posts 217 protruding from the assembling side 213, and the adapter circuit board 25 is provided with two latching holes 251 which engage with the two latching posts 217 respectively, so that before the external connecting segments 243 of the plurality of extension terminals 24 are welded with the adapter circuit board 25, the two latching posts 217 respectively pass through the two latching holes 251 to position the adapter circuit board 25 relative to the insulating frame 21, and at the same time the external connecting segments 243 of the plurality of extension terminals 24 respectively pass through corresponding welding holes 252 of the adapter circuit board 25, so as to facilitate the welding operation. And, in the embodiment, the adapter circuit board 25 is locked and fixed on the assembling side 213 of the insulating frame 21 via two fixing assemblies 27, each fixing assembly 27 comprises a bolt 271 which is provided to the insulating frame 21 and a nut 272 which can lock with the bolt 271. The adapter circuit board 25 is provided with two fixing holes 254 which respectively correspond to the two bolts 271 in position for passing through of the two bolts 271 respectively. By that the two nuts 272 lock with the two bolts 271 respectively, the adapter circuit board 25 is clamped and fixed onto the assembling side 213 of the insulating frame 21.

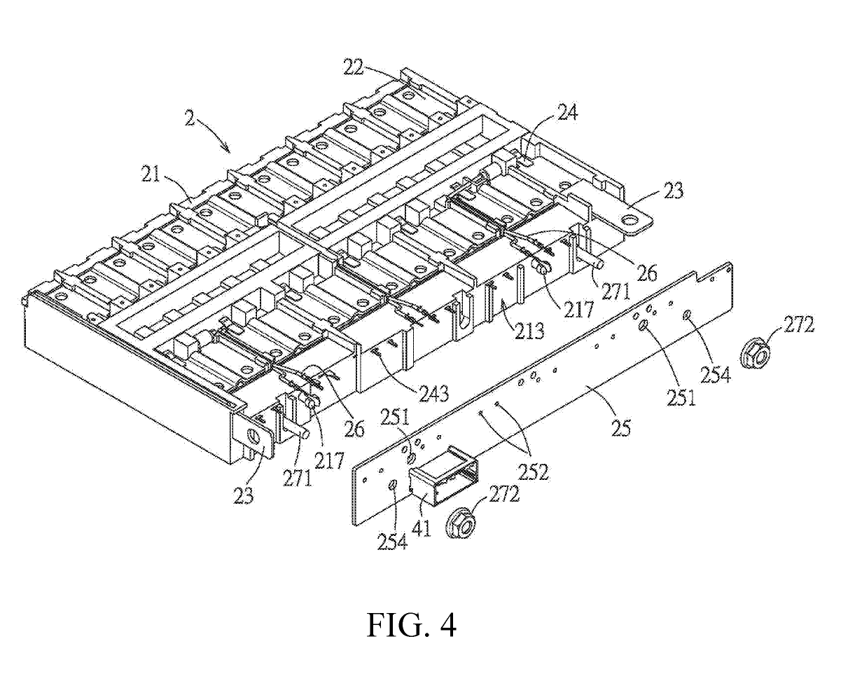

Referring to FIG. 4 and FIG. 7, the battery connection module 2 further comprises a plurality of sensing units 26 which are provided to the insulating frame 21. Each sensing unit 26 comprises a sensor 261 which is attached to one of the bus-bars 22B and two wires 262 which connect the sensor 261 and the adapter circuit board 25. The insulating frame 21 has a plurality of wire accommodating grooves 218, each wire accommodating groove 218 accommodates the two wires 262 of each sensing unit 26. In the embodiment, each sensing unit 26 further comprises two wire clamping terminals 263 which each are connected to a distal end of one of the two wires 262 and welded to the adapter circuit board 25, each sensing unit 26 is easily welded to the adapter circuit board 25 via the two wire clamping terminals 263, however, it can be also be implemented that the two wire clamping terminals 263 are omitted and the two wires 262 of each sensing unit 26 are directly welded to the adapter circuit board 25. In the embodiment, each sensor 261 is accommodated and fixed by an accommodating chamber 225 formed by the bus-bar 22B which is connected with each sensor 261, however, each sensor 261 can also be attached to the bus-bar 22B by a way such as applying an adhesive to adhere and fix each sensor 261, the present disclosure is not limited to this embodiment. In the embodiment, the sensor 261 is a negative temperature coefficient thermistor, it can be understood that, a type of the sensing unit 26 can be adjusted according to the requirement of use, and the number of sensing units 26 can be adjusted according to the requirement of use, that is, it can also be implemented that there is at least one sensing unit 26. Of course, the adapter circuit board 25 is formed with a predetermined circuit pattern (not shown).

Referring to FIG. 1 and FIG. 2, the battery management circuit board 3 is formed with a predetermined circuit pattern (not shown) and is mounted with electronic elements 31. The battery management circuit board 3 can be a circuit board of a Battery Management Unit (BMU) or a Battery Management System (BMS). The electrical connecting unit 4 connects the battery management circuit board 3 and the adapter circuit board 25 so as to make the battery management circuit board 3 detachably connected with the adapter circuit board 25. In the embodiment, the electrical connecting unit 4 comprises a first connector 41 which is provided to the adapter circuit board 25, a second connector 42 which is provided to the battery management circuit board 3 and a cable 43 which is pluggably connected with the first connector 41 and the second connector 42. Wires of the cable 43 are not shown in the figures, only two mating connectors 431 at two ends of the cable 43 are shown. When the battery management circuit board 3 is intended to connect with the adapter circuit board 25, the two mating connectors 431 at the two ends of the cable 43 are respectively connected to the first connector 41 provided to the adapter circuit board 25 and the second connector 42 provided to the battery management circuit board 3. When the battery management circuit board 3 is intended to detach from the adapter circuit board 25, it only needs to make the cable 43 detach from at least one of the first connector 41 and the second connector 42. Thus, when one of the battery pack 1 or the battery management circuit board 3 fails, the battery management circuit board 3 can be detached from the adapter circuit board 25, so as to replace the failed one. That is, only the failed one needs to be replaced, but the whole battery device will not be scrapped, so that the maintenance cost can also be saved. Especially the battery pack 1 has a certain service life, the battery pack 1 needs to be replaced after the battery pack 1 is used a period of time, by that the battery management circuit board 3 is detached from the adapter circuit board 25 and then is connected with the adapter circuit board 25 of the battery connection module 2 which is connected with a new battery pack 1, the battery management circuit board 3 can be repeatedly used, thereby reducing the cost of re-purchasing the battery management circuit board 3.

In the embodiment, the plurality of electrode connecting members 22 are firstly mounted to the insulating frame 21, and the plurality of electrode connecting members 22 respectively connect with the extension terminals 24 which are embedded to the insulating frame 21 and connect with the adapter circuit board 25 at the assembling side 213 of the insulating frame 21 via the extension terminals 24, it can simplify the procedure that the plurality of electrode connecting members 22 are welded with the adapter circuit board 25 by staying wires one by one, and the plurality of extension terminals 24 have already been fixed to the insulating frame 21 so that the plurality of electrode connecting members 22 and the adapter circuit board 25 can be positioned relative to the plurality of extension terminals 24, thereby also making the welding operation easily performed. Moreover, the plurality of electrode connecting members 22 and the adapter circuit board 25 can be assembled with the insulating frame 21 in advance so as to together form the battery connection module 2, thus when the battery connection module 2 is assembled with the battery pack 1, it only needs to align the through holes 223 of the plurality of electrode connecting members 22 with the electrodes of the battery pack 1 respectively and weld and fix the plurality of electrode connecting members 22 and the electrodes, this can simplify the assembling process and the battery management circuit board 3 can be connected after the battery connection module 2 and battery pack 1 have been assembled together, this can also be able to avoid damage to the battery management circuit board 3 during the welding process of the plurality of electrode connecting members 22 and the electrodes of the battery pack 1.

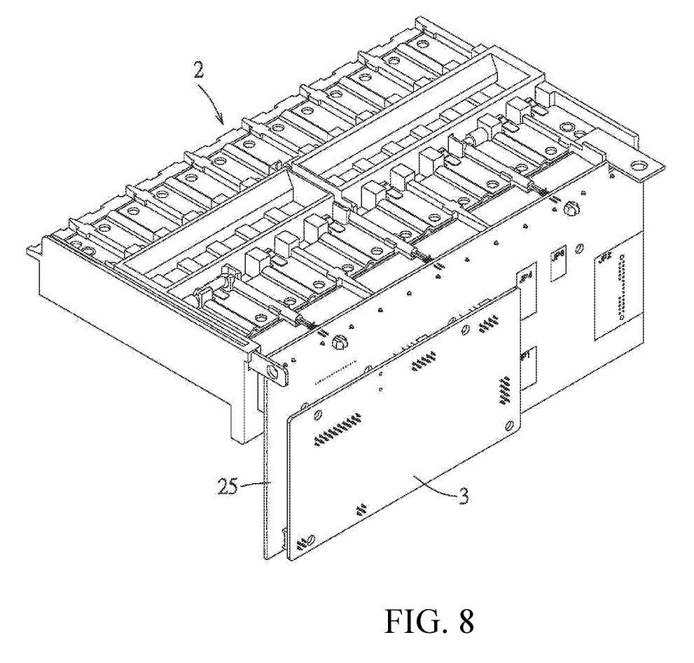

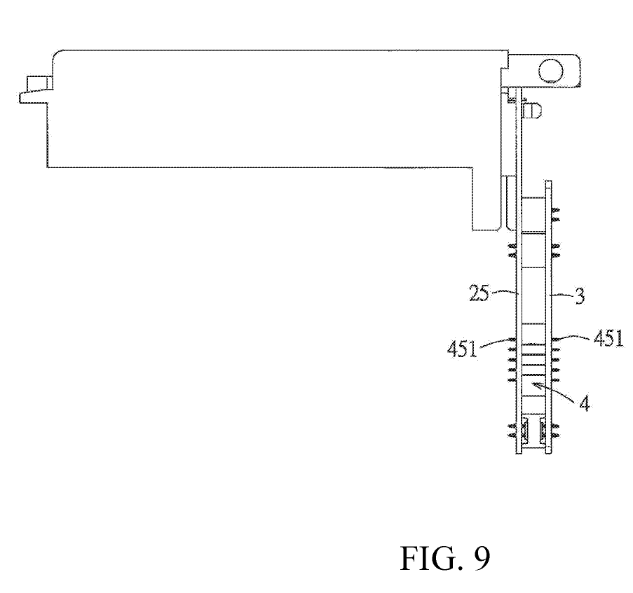

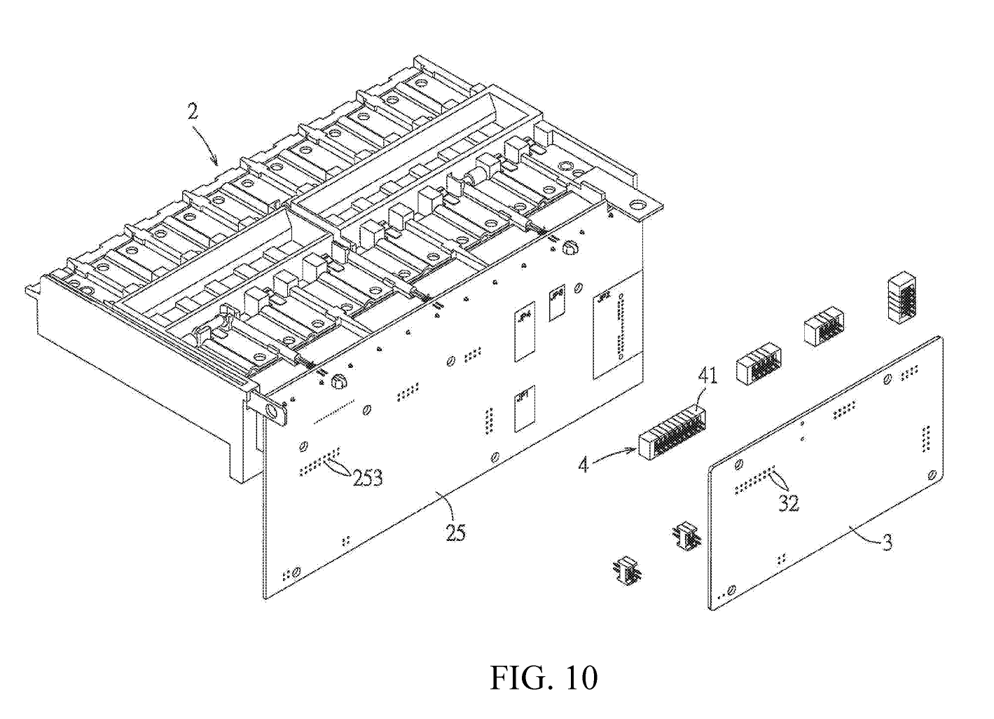

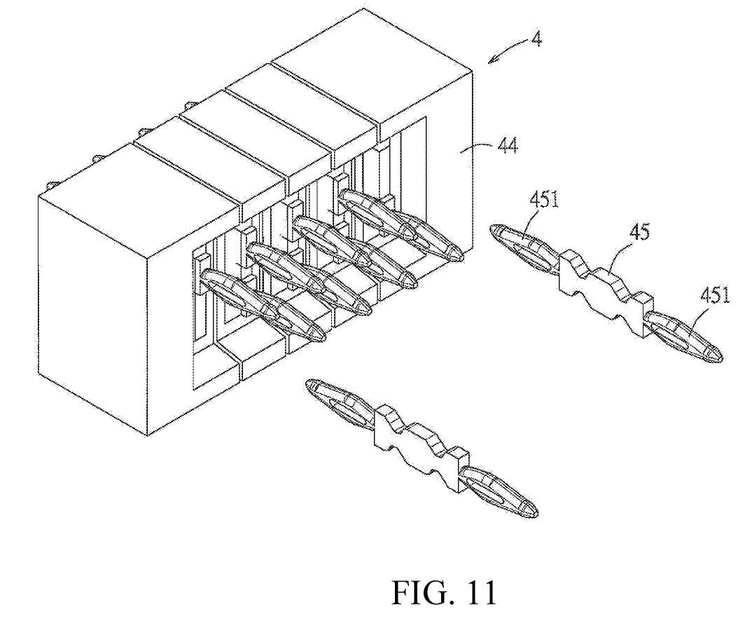

Referring to FIG. 8 through FIG. 11, a second embodiment of the battery device of the present disclosure is substantially the same as the first embodiment, however, in the second embodiment, the electrical connecting unit 4 comprises an insulating body 44 and a plurality of conductive terminals 45 fixed to the insulating body 44, each conductive terminal 45 has two compliance portions 451 respectively at opposite ends, in which one compliance portion 451 passes through a corresponding via 253 of the adapter circuit board 25, and the other compliance portion 451 passes through a corresponding via 32 of the battery management circuit board 3. When the adapter circuit board 25 is intended to detach from the battery management circuit board 3, it only needs to move one compliance portion 451 of each conductive terminal 45 out of the via 253 of the adapter circuit board 25 or it only needs to move the other compliance portion 451 of each conductive terminal 45 out of the via 32 of the battery management circuit board 3. In the second embodiment, the compliance portion 451 is in form of needle eye, but can also be in form of such as claw, the present disclosure is not limited to those. It can be understood that, the electrical connecting unit 4 can be provided as one or more in number according to practical requirements, and cannot be limited to the second embodiment.

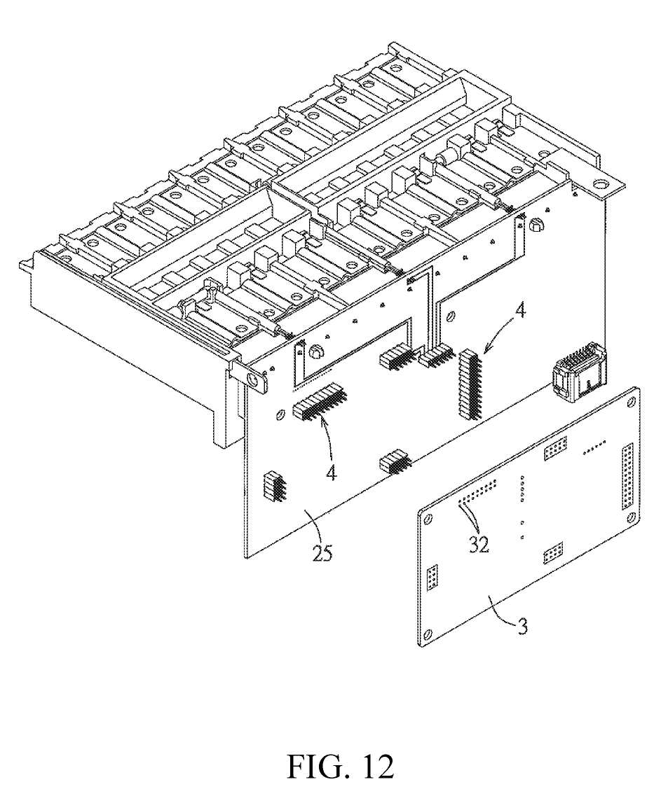

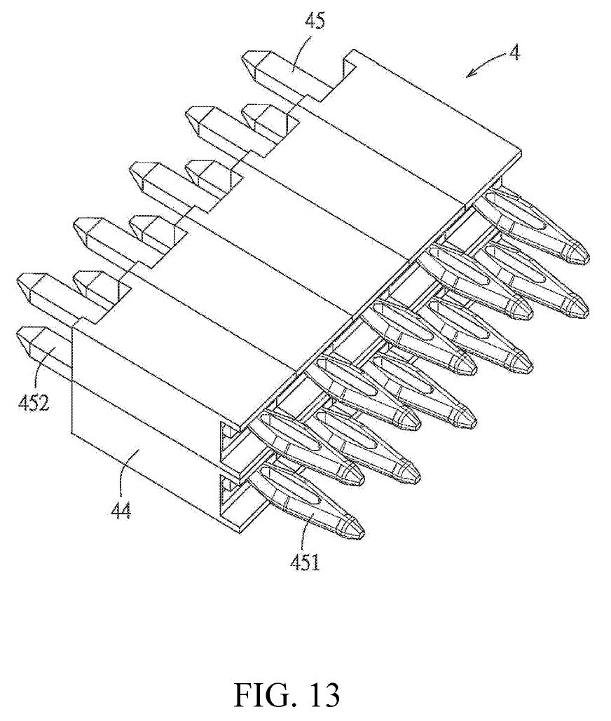

Referring to FIG. 12 and FIG. 13, a third embodiment of the battery device of the present disclosure is substantially the same as the second embodiment, however, in the third embodiment, each conductive terminal 45 has a compliance portion 451 and a welding portion 452 respectively at opposite ends, the compliance portion 451 passes through a corresponding via 32 of the battery management circuit board 3, and the welding portion 452 is welded to the adapter circuit board 25. Similarly, when the adapter circuit board 25 is intended to detach from the battery management circuit board 3, it only needs to move the compliance portion 451 of each conductive terminal 45 out of the via 32 of the battery management circuit board 3. It can be understood that, in an equivalent varied embodiment, it also can be implemented that the welding portion 452 is welded to the battery management circuit board 3 and the adapter circuit board 25 (referring to the second embodiment) is provided with a via 253 to make the compliance portion 451 pass through the via 253 of the adapter circuit board 25, which also has the same effect.

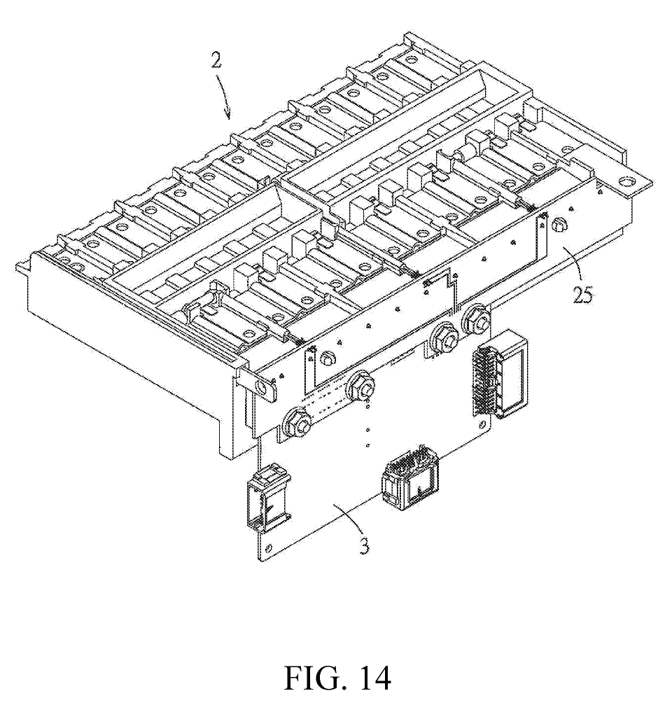

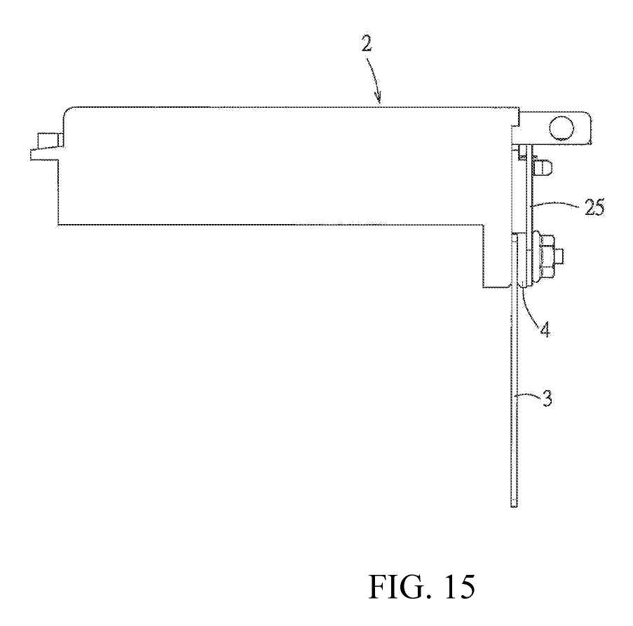

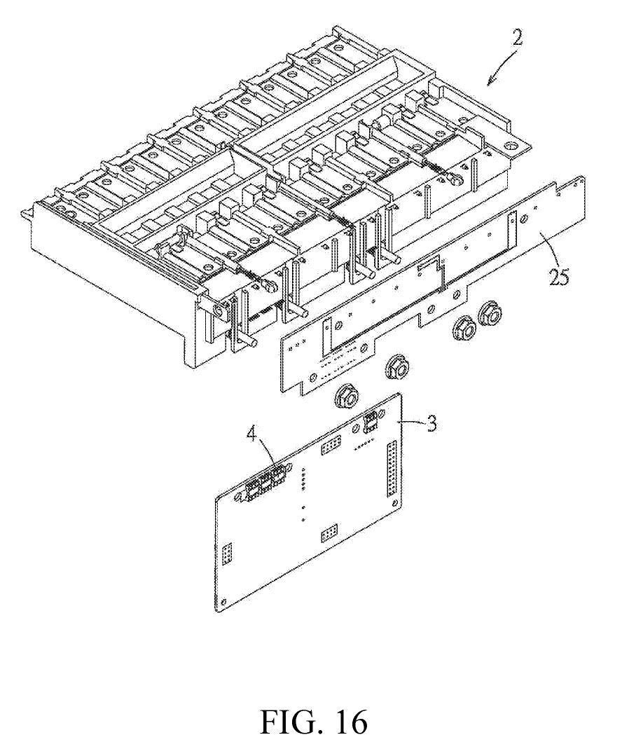

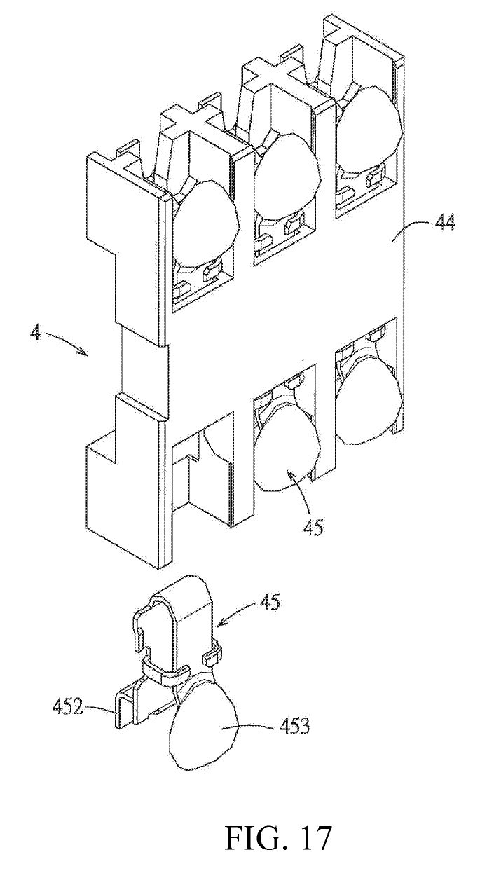

Referring to FIG. 14 through FIG. 17, a fourth embodiment of the battery device of the present disclosure is substantially the same as the second embodiment, however, in the embodiment, each conductive terminal 45 has a welding portion 452 and an elastic contacting portion 453, the welding portion 452 is welded to the battery management circuit board 3, and the elastic contacting portion 453 contacts a corresponding connection pad (not shown) which is provided to the adapter circuit board 25. In the third embodiment, two surfaces of the adapter circuit board 25 each are provided with a predetermined circuit pattern. By that the welding portion 452 of each conductive terminal 45 is welded and fixed to the battery management circuit board 3 and the elastic contacting portion 453 of the conductive terminal 45 contacts the corresponding connection pad provided to the adapter circuit board 25, the battery management circuit board 3 is detachably connected with the adapter circuit board 25. It can be understood that, in an equivalent varied embodiment, it also can be implemented that the welding portion 452 is welded to the adapter circuit board 25 and the battery management circuit board 3 is provided with a corresponding connection pad, which also has the same effect.

In conclusion, the insulating frame 21, the plurality of electrode connecting members 22, the plurality of extension terminals 24 and the adapter circuit board 25 together form the battery connection module 2, an assembling process of assembling them with the battery pack 1 can be simplified. And, the battery management circuit board 3 can be detachably connected with the adapter circuit board 25, which not only can avoid damage to the battery management circuit board 3 during the welding process of the plurality of electrode connecting members 22 and the electrodes of the battery pack 1, but also when one of the battery pack 1 and the battery management circuit board 3 fails, it only needs to replace the failed one, the whole battery device will not be scrapped, so that the maintenance cost can also be saved.

The above contents are merely embodiments of the present disclosure and the scope of implementing the present disclosure cannot be limited to those. Any simple equivalent changes and modifications made according to the scope of the claims and the contents of the specification of the present disclosure are fallen within the scope of the present disclosure.

1. A battery device, comprising:
a battery pack comprising a plurality of batteries, each battery having two electrodes;
a battery connection module comprising:
an insulating frame having an assembling side,
a plurality of electrode connecting members provided to the insulating frame and connecting the electrodes of the battery pack,
a plurality of extension terminals provided to the insulating frame and respectively corresponding to the plurality of electrode connecting members, each extension terminal having a fixed segment embedded to the insulating frame, an internal connecting segment exposed to the insulating frame and connected with the corresponding electrode connecting member and an external connecting segment extending out of the assembling side of the insulating frame, and
an adapter circuit board fixed to the assembling side of the insulating frame and connecting with the external connecting segments of the plurality of extension terminals;
a battery management circuit board; and
an electrical connecting unit connecting the battery management circuit board and the adapter circuit board to make the battery management circuit board detachably connected with the adapter circuit board.

2. The battery device according to claim 1, wherein in the plurality of electrode connecting members, multiple electrode connecting members are bus-bars, each bus-bar has at least two electrode connecting portions to respectively connect the electrodes of adjacent batteries and at least one arched buffer segment to connect adjacent electrode connecting portions.

3. The battery device according to claim 2, wherein in the plurality of electrode connecting members, two electrode connecting members are output electrode members and the other electrode connecting members are the bus-bars, the battery connection module further comprises two extending tabs connecting the two output electrode members respectively and extending out of the assembling side.

4. The battery device according to claim 2, wherein the battery connection module further comprises at least one sensing unit which is provided to the insulating frame, each sensing unit comprises a sensor attached to one of the bus-bars and two wires to connect each sensor and the adapter circuit board.

5. The battery device according to claim 4, wherein the sensing unit further comprises two wire clamping terminals which are connected to a distal end of one of the two wires and are welded to the adapter circuit board.

6. The battery device according to claim 5, wherein the insulating frame has at least one wire accommodating groove, each wire accommodating groove accommodates the two wires of each sensing unit.

7. The battery device according to claim 1, wherein the insulating frame further has a bottom side connecting the battery pack, a top side opposite to the bottom side and a plurality of electrode connecting members, and the assembling side is a side of an outer periphery of the insulating frame, each accommodating groove communicates the bottom side and the top side.

8. The battery device according to claim 7, wherein the internal connecting segment of each extension terminal extends into the corresponding accommodating groove and is welded to the corresponding electrode connecting member.

9. The battery device according to claim 8, wherein two walls defining each accommodating groove and opposite to each other are formed with a first stopping block close to the bottom side and a second stopping block close to the top side, a distance between the first stopping block and the second stopping block is greater that a thickness of the electrode connecting member so as to allow the electrode connecting member to move in a limited range in a vertical direction which vertically passes through the bottom side and the top side before the electrode connecting member is connected and fixed with the corresponding electrode.

10. The battery device according to claim 1, wherein the plurality of electrode connecting members each are made of aluminum-based metal material, the plurality of extension terminals each are made of copper-based metal material.

11. The battery device according to claim 1, wherein the electrical connecting unit comprises a first connector provided to the adapter circuit board, a second connector provided to the battery management circuit board and a cable of pluggably connected with the first connector and the second connector.

12. The battery device according to claim 1, wherein the electrical connecting unit comprise an insulating body and a plurality of conductive terminals fixed to the insulating body, each conductive terminal has two compliance portions respectively at opposite ends, in which one compliance portion passes through a corresponding via of the adapter circuit board, and the other compliance portion passes through a corresponding via of the battery management circuit board.

13. The battery device according to claim 1, wherein the electrical connecting unit comprises an insulating body and a plurality of conductive terminal fixed to the insulating body, each conductive terminal has a compliance portion and a welding portion respectively at opposite ends, the compliance portion passes through a corresponding via of one of the adapter circuit board and the battery management circuit board, and the welding portion is welded to the other of the adapter circuit board and the battery management circuit board.

14. The battery device according to claim 1, wherein the electrical connecting unit comprises an insulating body and a plurality of conductive terminals fixed to the insulating body, each conductive terminal has a welding portion and an elastic contacting portion, the welding portion is welded to one of the adapter circuit board and the battery management circuit board, and the elastic contacting portion contacts a corresponding connection pad provided to the other of the adapter circuit board and the battery management circuit board.

15. A battery connection module, comprising:
an insulating frame having an assembling side;
a plurality of electrode connecting members provided to the insulating frame;
a plurality of extension terminals provided to the insulating frame and respectively corresponding to the electrode connecting members, each extension terminal being partially embedded to the insulating frame and having an internal connecting segment exposed to the insulating frame and connected with the corresponding electrode connecting member and an external connecting segment extending out of the assembling side of the insulating frame; and
an adapter circuit board fixed to the assembling side of the insulating frame and connected with the external connecting segments of the plurality of extension terminals.

16. The battery connection module according to claim 15, wherein in the plurality of electrode connecting members, multiple electrode connecting members are bus-bar, each bus-bar has at least two electrode connecting portions and at least one arched buffer segment to connect adjacent electrode connecting portions.

17. The battery connection module according to claim 16, wherein in the plurality of electrode connecting members, two electrode connecting members are output electrode members and the other electrode connecting members are bus-bars, the battery connection module further comprises two extending tabs connecting the two output electrode members respectively and extending out of the assembling side.

18. The battery connection module according to claim 16, wherein the battery connection module further comprises at least one sensing unit provided to the insulating frame, each sensing unit comprises a sensor attached to one of the bus-bars and two wire to connect each sensor and the adapter circuit board.

19. The battery connection module according to claim 18, wherein each sensing unit further comprises two wire clamping terminals which each are connected to a distal end of one of the two wires and are welded to the adapter circuit board.

20. The battery connection module according to claim 19, wherein the insulating frame has at least one wire accommodating groove, each wire accommodating groove accommodates the two wires of each sensing unit.

21. The battery connection module according to claim 15, wherein the insulating frame further has a bottom side, a top side opposite to the bottom side and a plurality of accommodating grooves respectively accommodating the plurality of electrode connecting members, and the assembling side is a part of an outer periphery of the insulating frame, each accommodating groove communicates the bottom side and the top side.

22. The battery connection module according to claim 21, wherein the internal connecting segment of each extension terminal extends into the corresponding accommodating groove and is welded to the corresponding electrode connecting member.

23. The battery connection module according to claim 22, wherein two walls defining each accommodating groove and opposite to each other each are formed with a first stopping block close to the bottom side and a second stopping block close to the top side, a distance between the first stopping block and the second stopping block is greater than a thickness of the electrode connecting member, so as to allow the electrode connecting member to move in a limited range in a vertical direction which vertically passes through the bottom side and the top side.

24. The battery connection module according to claim 15, wherein the plurality of electrode connecting members each are made of aluminum-based metal material, the plurality of extension terminals each are made of copper-based metal material.
